(19) United States
(12) Patent Application Publication
(10) Pub. No.: US 2023/0007683 A1
(43) Pub. Date: Jan. 5, 2023

(54) RANDOM ACCESS FOR SECONDARY USER EQUIPMENT

(71) Applicant: QUALCOMM Incorporated, San Diego, CA (US)

(72) Inventors: Qiaoyu LI, Beijing (CN); Chao WEI, Beijing (CN); Wanshi CHEN, San Diego, CA (US); Huilin XU, Temecula, CA (US); Jing LEI, San Diego, CA (US); Peter Pui Lok ANG, San Diego, CA (US); Min HUANG, Beijing (CN); Yu ZHANG, San Diego, CA (US); Chenxi HAO, Beijing (CN); Hao XU, Beijing (CN)

(21) Appl. No.: 17/756,006

(22) PCT Filed: Nov. 14, 2019
(86) PCT No.: PCT/CN2019/118306

§ 371 Date: May 13, 2022

(51) Int. Cl. H04W 74/00; H04W 74/08; H04W 76/14; H04W 72/04

(52) U.S. Cl. CPC H04W 74/002; H04W 74/0833; H04W 76/14; H04W 72/0406; H04W 92/18

(57) ABSTRACT

Various aspects of the present disclosure generally relate to wireless communication. In some aspects, a primary user equipment (UE) may transmit, on a sidelink, information indicating a set of sidelink random access configurations corresponding to a set of uplink random access configurations; receive, on the sidelink and from a secondary UE, a random access signal based at least in part on a selected sidelink random access configuration of the set of sidelink random access configurations, wherein the selected sidelink random access configuration corresponds to a selected uplink random access configuration of the set of uplink random access configurations; and selectively performing a random access procedure in accordance with the selected uplink random access configuration. Numerous other aspects are provided.

### FIELD OF THE DISCLOSURE

Aspects of the present disclosure generally relate to wireless communication and to techniques and apparatuses for random access for secondary user equipment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a primary user equipment (UE), may include transmitting, on a sidelink, information indicating a set of sidelink random access configurations corresponding to a set of uplink random access configurations; receiving, on the sidelink and from a secondary UE, a random access signal based at least in part on a selected sidelink random access configuration of the set of sidelink random access configurations, wherein the selected sidelink random access configuration corresponds to a selected uplink random access configuration of the set of uplink random access configurations; and selectively performing a random access procedure in accordance with the selected uplink random access configuration.

In some aspects, a method of wireless communication, performed by a secondary UE, may include determining a selected uplink random access configuration for a random access procedure; receiving, on a sidelink and from a primary UE, system information indicating a sidelink random access configuration corresponding to the selected uplink random access configuration; and transmitting, on the sidelink and to the primary UE, a random access signal indicated by the sidelink random access configuration.

In some aspects, a method of wireless communication, performed by a base station, may include receiving a random access signal associated with a random access procedure, wherein the random access signal is associated with a group of random access preambles; determining a repetition scheme for a transmission of the base station based at least in part on the random access signal; and performing the transmission using the repetition scheme.

In some aspects, a primary UE for wireless communication may include memory and one or more processors operatively coupled to the memory. The memory and the one or more processors may be configured to transmit, on a sidelink, information indicating a set of sidelink random access configurations corresponding to a set of uplink random access configurations; receive, on the sidelink and from a secondary UE, a random access signal based at least in part on a selected sidelink random access configuration of the set of sidelink random access configurations, wherein the selected sidelink random access configuration corresponds to a selected uplink random access configuration of the set of uplink random access configurations; and selectively perform a random access procedure in accordance with the selected uplink random access configuration.

In some aspects, a secondary UE for wireless communication may include memory and one or more processors operatively coupled to the memory. The memory and the one or more processors may be configured to determine a selected uplink random access configuration for a random access procedure; receive, on a sidelink and from a primary UE, system information indicating a sidelink random access configuration corresponding to the selected uplink random access configuration; and transmit, on the sidelink and to the primary UE, a random access signal indicated by the sidelink random access configuration.

In some aspects, a base station for wireless communication may include memory and one or more processors operatively coupled to the memory. The memory and the one or more processors may be configured to receive a random access signal associated with a random access procedure, wherein the random access signal is associated with a group of random access preambles; determine a repetition scheme for a transmission of the base station based at least in part on the random access signal; and perform the transmission using the repetition scheme.

In some aspects, a non-transitory computer-readable medium may store one or more instructions for wireless communication. The one or more instructions, when executed by one or more processors of a primary UE, may cause the one or more processors to: transmit, on a sidelink, information indicating a set of sidelink random access configurations corresponding to a set of uplink random access configurations; receive, on the sidelink and from a secondary UE, a random access signal based at least in part on a selected sidelink random access configuration of the set of sidelink random access configurations, wherein the selected sidelink random access configuration corresponds to a selected uplink random access configuration of the set of uplink random access configurations; and selectively perform a random access procedure in accordance with the selected uplink random access configuration.

In some aspects, a non-transitory computer-readable medium may store one or more instructions for wireless communication. The one or more instructions, when executed by one or more processors of a secondary UE, may cause the one or more processors to: determine a selected uplink random access configuration for a random access procedure; receive, on a sidelink and from a primary UE, system information indicating a sidelink random access configuration corresponding to the selected uplink random access configuration; and transmit, on the sidelink and to the primary UE, a random access signal indicated by the sidelink random access configuration.

In some aspects, a non-transitory computer-readable medium may store one or more instructions for wireless communication. The one or more instructions, when executed by one or more processors of a base station, may cause the one or more processors to: receive a random access signal associated with a random access procedure, wherein the random access signal is associated with a group of random access preambles; determine a repetition scheme for a transmission of the base station based at least in part on the random access signal; and perform the transmission using the repetition scheme.

In some aspects, an apparatus for wireless communication may include means for transmitting, on a sidelink, information indicating a set of sidelink random access configurations corresponding to a set of uplink random access configurations; means for receiving, on the sidelink and from a secondary user equipment, a random access signal based at least in part on a selected sidelink random access configuration of the set of sidelink random access configurations, wherein the selected sidelink random access configuration corresponds to a selected uplink random access configuration of the set of uplink random access configurations; and means for selectively performing a random access procedure in accordance with the selected uplink random access configuration.

In some aspects, an apparatus for wireless communication may include means for determining a selected uplink random access configuration for a random access procedure; means for receiving, on a sidelink and from a primary user equipment, system information indicating a sidelink random access configuration corresponding to the selected uplink random access configuration; and means for transmitting, on the sidelink and to the primary user equipment, a random access signal indicated by the sidelink random access configuration.

In some aspects, an apparatus for wireless communication may include means for receiving a random access signal associated with a random access procedure, wherein the random access signal is associated with a group of random access preambles; means for determining a repetition scheme for a transmission of the apparatus based at least in part on the random access signal; and means for performing the transmission using the repetition scheme.

Aspects generally include a method, apparatus, system, computer program product, non-transitory computer-readable medium, user equipment, base station, wireless communication device, and/or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating an example of four-step and two-step random access procedures, in accordance with various aspects of the present disclosure.

FIG. 4 is a diagram illustrating an example of random access for a secondary UE, in accordance with various aspects of the present disclosure.

FIG. 5 is a diagram illustrating an example process performed, for example, by a user equipment, in accordance with various aspects of the present disclosure.

FIG. 6 is a diagram illustrating an example process performed, for example, by a user equipment, in accordance with various aspects of the present disclosure.

FIG. 7 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

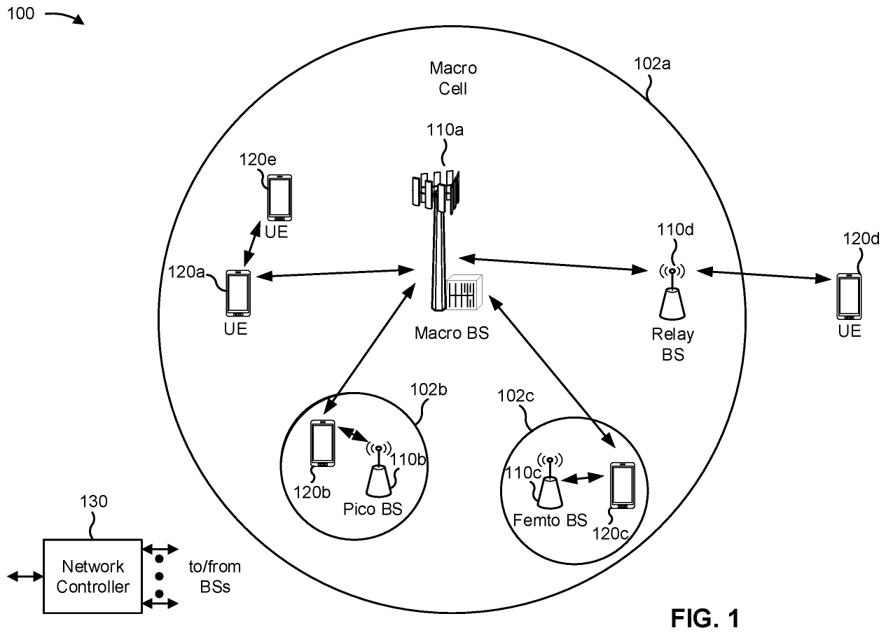

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP,”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

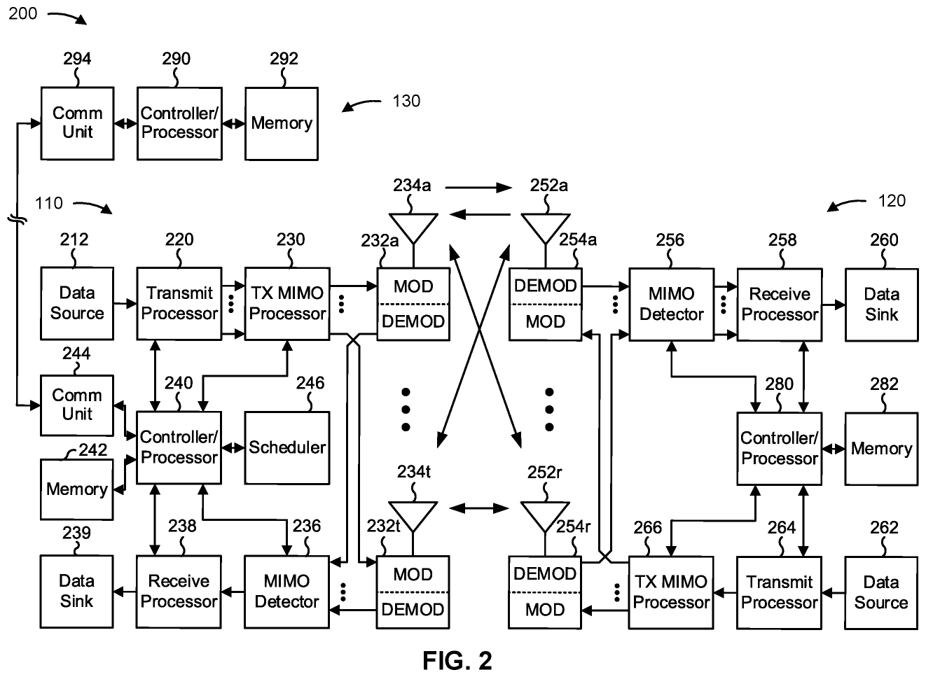

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

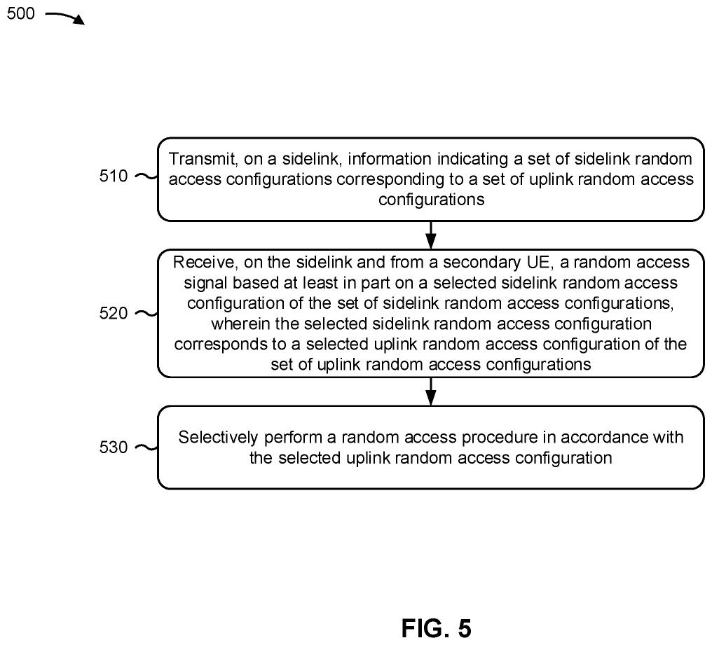

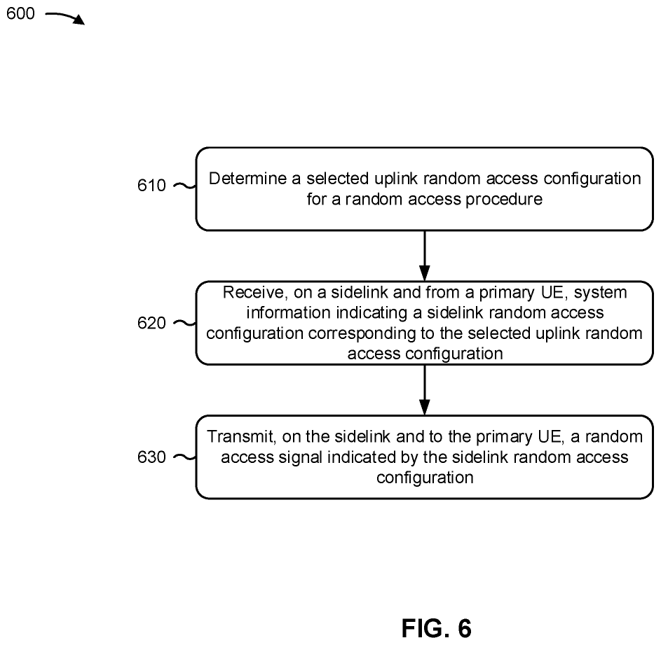

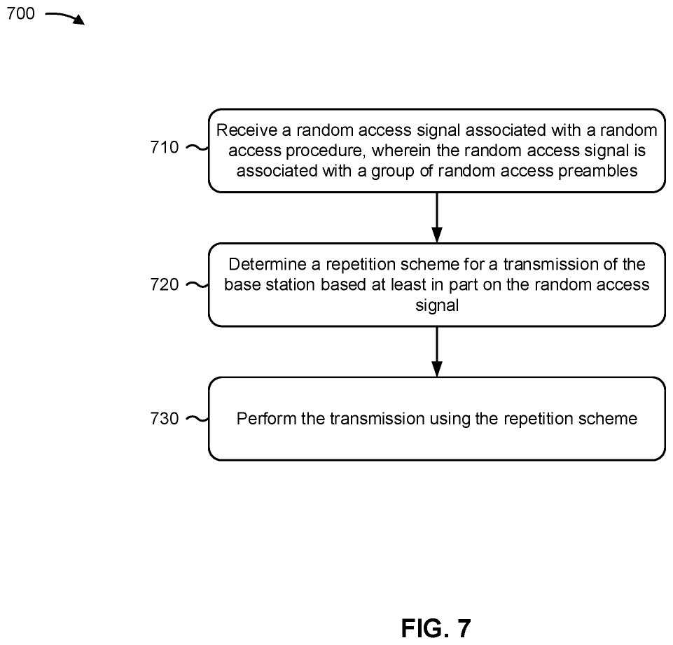

Controller/processor 240 of base station 110, controller/processor 280 of UE 120, and/or any other component(s) of FIG. 2 may perform one or more techniques associated with random access for a secondary UE, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, process 700 of FIG. 7, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 500 of FIG. 5, process 600 of FIG. 6, process 700 of FIG. 7, and/or other processes as described herein. A scheduler 246 may schedule UEs for data transmission on the downlink and/or uplink.

In some aspects, UE 120 may include means for transmitting, on a sidelink, information indicating a set of sidelink random access configurations corresponding to a set of uplink random access configurations; means for receiving, on the sidelink and from a secondary UE, a random access signal based at least in part on a selected sidelink random access configuration of the set of sidelink random access configurations; means for selectively performing a random access procedure in accordance with the selected uplink random access configuration; means for selecting a selected random access configuration of the primary UE; means for transmitting information to the secondary UE based at least in part on selectively performing the random access procedure in accordance with the selected uplink random access configuration; means for performing the random access procedure using a random access preamble associated with a repetition level to be used for a reception by the secondary UE; means for determining a selected uplink random access configuration for a random access procedure; means for receiving, on a sidelink and from a primary UE, system information indicating a sidelink random access configuration corresponding to the selected uplink random access configuration; means for transmitting, on the sidelink and to the primary UE, a random access signal indicated by the sidelink random access configuration; means for receiving, from a base station, a synchronization signal block, wherein the random access procedure is associated with the base station, and wherein the UE transmits the random access signal in accordance with a sidelink random access channel (RACH) occasion and a sidelink random access preamble that are selected in accordance with the synchronization signal block and the selected uplink random access configuration; means for receiving information from the primary UE indicating whether the random access procedure was successfully performed by the primary UE on behalf of the secondary UE; means for receiving information from the primary UE indicating that the random access procedure was successfully performed by the primary UE on behalf of the secondary UE; means for receiving a random access response, associated with the random access procedure, from the primary UE; means for receiving, from the primary UE, information indicating a preamble sequence for the random access procedure; means for receiving, from a base station, a random access message of the random access procedure based at least in part on the preamble sequence; means for receiving, from a base station, a random access message of the random access procedure, wherein a preamble sequence used by the primary UE for the random access procedure is indicated by the sidelink random access configuration, and wherein the random access message is received based at least in part on the preamble sequence; means for receiving, from a base station, a random access message of the random access procedure; means for performing a transmission using a timing correction associated with the random access message; means for receiving, from a base station, a communication with a plurality of repetitions, wherein the plurality of repetitions are based at least in part on a preamble sequence used to perform the random access procedure; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for receiving a random access signal associated with a random access procedure, wherein the random access signal is associated with a group of random access preambles; means for determining a repetition scheme for a transmission of the base station based at least in part on the random access signal; means for performing the transmission using the repetition scheme; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

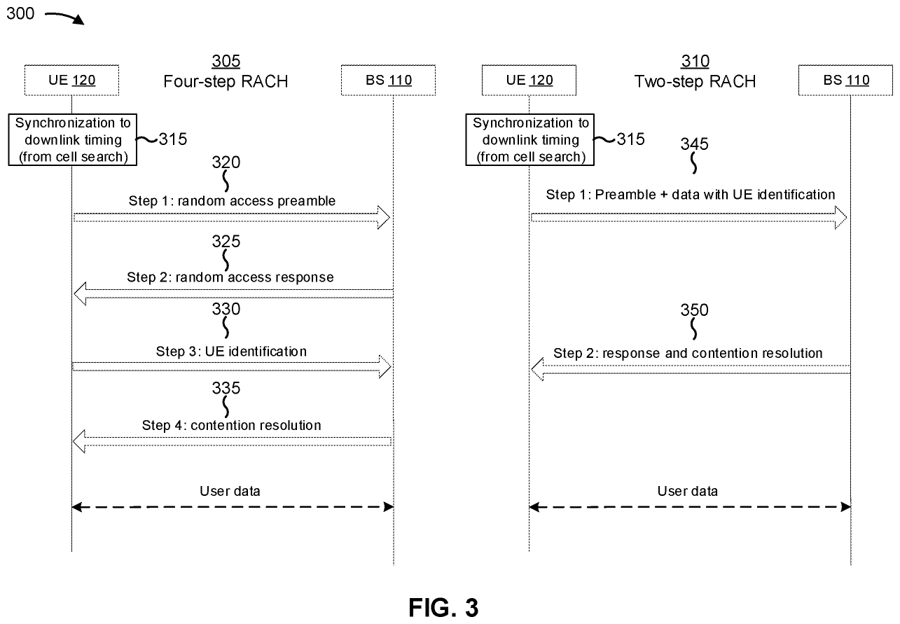

FIG. 3 is a diagram illustrating an example 300 of four-step and two-step random access procedures. FIG. 3 shows a four-step random access channel (RACH) procedure 305 and a two-step RACH procedure 310. The operations described in FIG. 3 are performed by a UE 120 and a BS 110. The UE 120 may use the RACH procedures shown in FIG. 3 for initial access or access from a radio resource control (RRC) idle mode, to achieve uplink synchronization between the UE 120 and the BS 110, and to establish or re-establish an RRC connection between the UE 120 and the BS 110.

As shown in FIG. 3 and by reference numbers 315, in the four-step RACH procedure 305 and the two-step RACH procedure 310, the UE 120 may synchronize to downlink timing of the BS 110. For example, the UE 120 may synchronize to the downlink timing based at least in part on a reference signal, a synchronization signal, a synchronization signal block (SSB), and/or the like.

As shown by reference number 320, in the four-step RACH procedure 305, the UE 120 may transmit a random access preamble. For example, the UE 120 may transmit a random access signal generated based at least in part on the random access preamble. The random access preamble may be selected from a pool of possible random access preambles, as described elsewhere herein. In some aspects, the UE 120 may transmit the random access preamble using particular resources identified by an SSB, known as a RACH occasion. The message shown by reference number 320 may be referred to as RACH Message 1 or RACH Msg1. Generally, messages of the four-step RACH procedure 305 are identified by numbers (e.g., RACH Messages 1 through 4), whereas messages of the two-step RACH procedure 310 are identified by letters (e.g., RACH Messages A and B).

As shown by reference number 325, the UE 120 may receive a random access response (sometimes abbreviated RAR) from the BS 110 in a second RACH message (e.g., RACH Message 2 or RACH Msg2). The random access response may be transmitted using a random access radio network temporary identifier (RA-RNTI) determined based at least in part on the resource used to transmit the preamble (e.g., a time/frequency allocation) so that the UE 120 can decode the random access response. In some aspects, the random access response may include a resource block assignment for the UE 120, a modulation and coding scheme (MCS) configuration, and/or the like.

As shown by reference number 330, the UE 120 may transmit UE information to the BS 110 in a third RACH message (e.g., RACH Message 3 or Rach Msg3). In some aspects, the UE information may include an RRC connection request, a UE identity of the UE 120, and/or the like.

As shown by reference number 335, the UE 120 may receive contention resolution information from the BS 110 in a fourth RACH message (e.g., RACH Message 4 or RACH Msg4). For example, the contention resolution information may include, for example, a cell-specific RNTI (C-RNTI) and/or the like. In some aspects, the fourth RACH message may include RRC connection setup information.

In the two-step RACH procedure 310, certain aspects of the four-step RACH procedure are combined in order to reduce latency and overhead associated with random access. For example, and as shown by reference number 345, a first RACH message (e.g., RACH Message A or RACH MsgA) may include a preamble, a data payload, and/or UE identification information. In other words, RACH Messages 1 and 3 of the four-step RACH procedure 305 may be combined in RACH Message A. As another example, shown by reference number 345, a second RACH message (e.g., RACH Message B or RACH MsgB) may include a random access response and contention resolution information. In other words, RACH Messages 2 and 4 of the four-step RACH procedure may be combined in RACH Message B.

As indicated above, FIG. 3 is provided as an example. Other examples may differ from what is described with respect to FIG. 3.

A UE may use a RACH procedure, such as the four-step RACH procedure 305 or the two-step RACH procedure 310, to access a network provided by a BS 110. Some UEs may be low-cost, low-complexity UEs, or low-power UEs. Examples include wearable devices, medical monitoring devices, Internet of Things (IoT devices), machine-type communication (MTC) devices, and/or the like. The RACH procedure may consume significant power, particularly for low-power UEs, since such UEs may use repetitious communications for coverage enhancement. The usage of repetitions for RACH messages of a RACH procedure may further increase power usage of low-power UEs.

Some techniques and apparatuses described herein provide for a primary UE to perform at least part of a RACH procedure on behalf of a secondary UE. For example, the secondary UE may be a low-power, low-cost, or low-complexity UE, and may be linked to the primary UE by a sidelink connection. The secondary UE may transmit a random access signal to the primary UE that indicates an uplink RACH configuration selected by the secondary UE for accessing a base station. The primary UE may transmit a random access signal to the base station in accordance with the uplink RACH configuration. The random access signal from the secondary UE to the primary UE may use a lower transmit power than if the secondary UE were to transmit a random access signal to the base station. Thus, power usage and computing resource usage of the secondary UE are reduced. Some techniques and apparatuses described herein also provide for signaling of a repetition scheme to be used by a base station based at least in part on a random access preamble used for the RACH procedure, thereby reducing signaling overhead and conserving computing resources of the secondary UE and the base station.

In this way, the transmit power used for RACH procedures of the secondary UE is reduced. Furthermore, the secondary UE may have a full RRC connection with the base station, so a straightforward link recovery procedure can be carried out when the secondary UE loses the sidelink connection but is still within the base station's range. Particularly, in such cases, the secondary UE may not have to perform another full RACH procedure, which saves power consumption. Furthermore, power usage by the secondary UE may be reduced when the secondary UE already has an established RRC connection with the BS and upper-layer encryptions are already configured. In other words, the techniques and apparatuses described herein can be applied for the establishment of a new RRC connection or for random access procedures associated with an existing RRC connection.

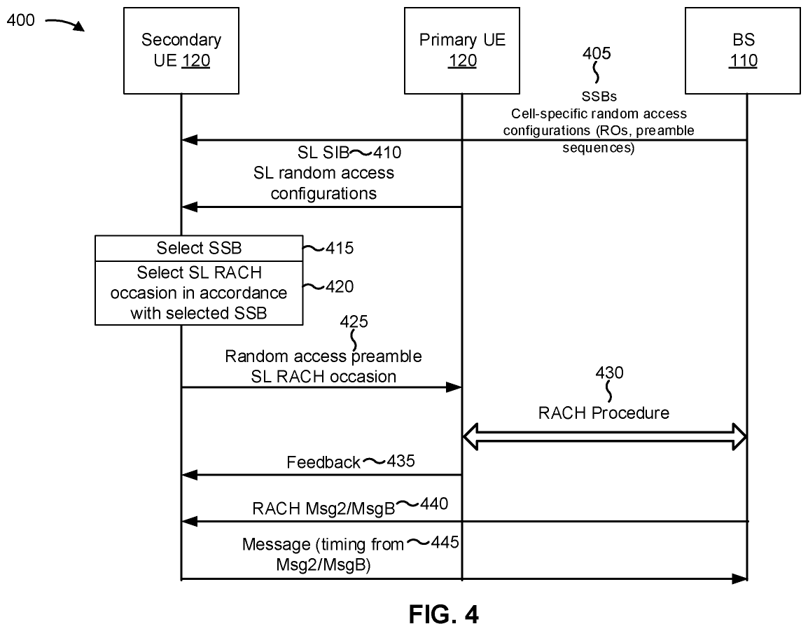

FIG. 4 is a diagram illustrating an example 400 of random access for a secondary UE, in accordance with various aspects of the present disclosure. As shown, example 400 includes a primary UE 120, a secondary UE 120, and a BS 110. The operations described herein can be performed by any pair of UEs 120. In some aspects, the operations described herein may be particularly beneficial for secondary UEs 120 that are low-complexity UEs, low-power UEs, low-cost UEs, and/or the like. For example, a secondary UE 120 such as a wearable device, a medical monitoring device, a small form factor device, a low battery capacity device, and/or the like, may use the techniques and apparatuses described herein to reduce battery usage, transmit power, and computing resource usage in association with RACH procedures. In some aspects, the primary UE 120 and the secondary UE 120 may be associated with cellular air interface links to the BS 110 (e.g., Uu interface links and/or the like). In some aspects, the primary UE 120 may be associated with a sidelink interface to the secondary UE 120.

As shown by reference number 405, the secondary UE 120 may receive one or more SSBs from the BS 110. An SSB may indicate a cell-specific random access configuration, referred to herein as an uplink random access configuration. For example, an uplink random access configuration may identify a set of random access preamble sequences associated with the SSB, a RACH occasion associated with the SSB and/or the set of random access preambles, and/or the like.

In some aspects, the primary UE 120 may also receive the one or more SSBs. For example, the primary UE 120 and the secondary UE 120 may be covered by a same one or more cells on which the one or more SSBs are transmitted. This may occur when the primary UE 120 and the secondary UE 120 are collocated or are in close proximity to each other, such as when the primary UE 120 is a cellular phone and the secondary UE 120 is a wearable device worn by a user of the primary UE 120. In this case, the transmit power for the secondary UE 120 to transmit to the primary UE 120 may be lower than for the secondary UE 120 to transmit to the BS 110.

As shown by reference number 410, the secondary UE 120 may receive one or more sidelink (SL) system information blocks (SIBs) from the primary UE 120. For example, the primary UE 120 may provide the one or more sidelink SIBs on the sidelink connection between the primary UE 120 and the secondary UE 120. A sidelink SIB may identify one or more sidelink random access configurations. For example, a sidelink random access configuration may identify a sidelink random access preamble, a sidelink RACH occasion, and/or an association of the sidelink random access preamble and/or the sidelink RACH occasion with an SSB or an uplink random access configuration. In some aspects, the primary UE 120 may provide respective sidelink random access configurations corresponding to a plurality of uplink random access configurations. In some aspects, a sidelink random access configuration may identify a time-frequency resource configuration for use by the secondary UE 120 to transmit or receive subsequent communications with the primary UE 120.

In some aspects, the information described above as being provided in a sidelink SIB may be provided to the secondary UE 120 by other means, such as a sidelink RRC configuration and/or the like. Additionally, or alternatively, such information may be pre-configured, such as by way of a wireless telecommunication standard.

The sidelink random access preamble may be configured to use a lower transmit power than an uplink random access preamble. For example, the sidelink random access preamble, relative to the uplink random access preamble, may have fewer possible preamble sequences, a smaller subcarrier spacing, shorter preamble sequences, a smaller cyclic shift, and/or the like. Thus, the secondary UE 120 may conserve power and reduce complexity associated with random access by using a lower-power or lower-complexity random access preamble to trigger the primary UE 120 to perform random access.

As shown by reference number 415, the secondary UE 120 may select an SSB (e.g., an uplink random access configuration associated with the SSB). For example, the secondary UE 120 may select the SSB for performance of the RACH procedure using an uplink random access configuration (e.g., a RACH occasion and random access preamble) associated with the SSB. In some aspects, the selection of the SSB may be referred to as selecting a preferred SSB or a selected SSB.

In some aspects, the primary UE 120 may select an SSB. For example, the primary UE 120 may select a preferred SSB or selected SSB. In some aspects, the primary UE 120 may perform the operations indicated by reference number 430 only if the selected SSB of the primary UE 120 matches the selected SSB of the secondary UE 120. In some aspects, the primary UE 120 may perform the operations indicated by reference number 430 even though the selected SSBs of the primary UE 120 and the secondary UE 120 do not match. For example, the primary UE 120 may selectively perform the RACH procedure if a difference between the selected SSBs of the primary UE 120 and the secondary UE 120 satisfies a threshold (e.g., if the selected SSBs are sufficiently similar in configuration).

As shown by reference number 420, the secondary UE 120 may select a sidelink RACH occasion in accordance with the selected SSB. For example, the secondary UE 120 may select a sidelink random access configuration associated with the selected SSB. Thus, the UE 120 may identify a sidelink RACH occasion and random access preamble corresponding to the selected SSB.

As shown by reference number 425, the secondary UE 120 may transmit a random access signal (e.g., a random access preamble) to the primary UE 120 on a sidelink RACH occasion. For example, the sidelink RACH occasion and the random access signal may correspond to a sidelink random access configuration associated with the selected SSB. Thus, the secondary UE 120 may indicate, to the primary UE 120, the SSB and uplink random access configuration for which the primary UE 120 is to perform the RACH procedure.

As shown by reference number 430, the primary UE 120 may perform at least part of a RACH procedure with the BS 110 on behalf of the secondary UE 120. For example, the primary UE 120 may transmit one or more of a RACH Message 1, a RACH Message A, or a RACH Message 3 to the BS 110 using a RACH occasion and a random access signal identified by the uplink random access configuration. In some aspects, the primary UE 120 may perform an entirety of the RACH procedure on behalf of the secondary UE 120, and may provide contention information or RRC connection information to the secondary UE 120 for establishment of the RRC connection with the BS 110. In some aspects, the primary UE 120 may transmit only an initial message of the RACH procedure (e.g., RACH Message 1 or RACH Message A), and the secondary UE 120 may handle subsequent communications with the BS 110, as described in more detail below. In some aspects, the primary UE 120 may handle uplink communications with the BS 110, and the secondary UE 120 may receive downlink communications from the BS 110.

As shown by reference number 435, in some aspects, the primary UE 120 may provide feedback to the secondary UE 120. In some aspects, the feedback may indicate whether the RACH procedure is successful (e.g., whether the primary UE 120 has received a random access response from the BS 110). In some aspects, the feedback may indicate whether the primary UE 120 will perform the RACH procedure. For example, in a case when the primary UE 120 will not perform the RACH procedure due to selecting a different SSB than the secondary UE 120, the feedback may indicate that the primary UE 120 will not perform the RACH procedure. In some aspects, the primary UE 120 may provide the feedback only if the primary UE 120 is to perform the RACH procedure or has performed the RACH procedure. In some aspects, the feedback may include random access information, such as one or more parts of a RACH Message 2, a RACH Message 4, or a RACH Message B.

As shown by reference number 440, in some aspects, the secondary UE 120 may receive a RACH message from the BS 110. For example, in some aspects, the secondary UE 120 may monitor a RACH Message 2 or a RACH Message B from the BS 110 according to the random access preamble sequence used by the primary UE 120 to transmit the random access signal to the BS 110. For example, before monitoring the RACH message from the BS 110, the secondary UE 120 may receive a sidelink message from the primary UE 120 identifying the random access preamble sequence used by the primary UE 120 to transmit the random access preamble. As another example, the random access preamble sequence used by the primary UE 120 may be determined by a sidelink preamble sequence and RACH occasion, and by the sidelink random access configuration. Thus, the secondary UE 120 may reduce the amount of information obtained by the primary UE 120 regarding the secondary UE 120 (e.g., UE-specific RNTIs and/or the like), thereby improving security of the secondary UE 120 while reducing transmit power for random access preambles.

As shown by reference number 445, in some aspects, the secondary UE 120 may transmit a message to the BS 110 using timing information determined based at least in part on the RACH message received from the BS 110. For example, the secondary UE 120 may use timing correction information in the received RACH Message 2 or RACH Message B (shown in connection with reference number 440) for a transmission to the BS 110. This may be feasible because the secondary UE 120 may be located close to or collocated with the primary UE 120 that transmitted the random access signal, and because the secondary UE 120 may be synchronized with the primary UE 120.

In some aspects, the secondary UE 120 may use a repetition scheme to communicate with the BS 110 in order to reduce transmit power and number of receive antennas used for a communication. In this case, it may be beneficial to indicate, to the BS 110, that a random access signal received from a primary UE 120 is transmitted on behalf of a secondary UE 120. For example, a group of random access preamble sequences or RACH occasions may be used to indicate that the random access signal is on behalf of the secondary UE 120 and/or to indicate that a repetition scheme is to be used for the RACH procedure. In some aspects, multiple, different groups of random access preamble sequences or RACH occasions may be used to indicate respective repetition schemes. For example, a first group of random access preamble sequences or RACH occasions may indicate a repetition level of 1, a second group of random access preamble sequences or RACH occasions may indicate a repetition level of 2, and so on. In this case, the sidelink random access configuration may include information indicating a mapping of repetition schemes to groups of random access preamble sequences or RACH occasions. Thus, the primary UE 120 may indicate a repetition scheme for communication with the secondary ULE 120 to the BS 110 as part of the RACH procedure, thereby reducing overhead, improving efficiency of communication between the secondary UE 120 and the BS 110, and improving utilization of computing resources.

As indicated above, FIG. 4 is provided as an example. Other examples may differ from what is described with respect to FIG. 4.

FIG. 5 is a diagram illustrating an example process 500 performed, for example, by a UE, in accordance with various aspects of the present disclosure. Example process 500 is an example where a primary UE (e.g., UE 120, primary UE 120 of FIG. 4, and/or the like) performs operations associated with random access for a secondary UE.

As shown in FIG. 5, in some aspects, process 500 may include transmitting, on a sidelink, information indicating a set of sidelink random access configurations corresponding to a set of uplink random access configurations (block 510). For example, the primary UE (e.g., using controller/processor 280, transmit processor 264, TX MIMO processor 266, MOD 254, antenna 252, and/or the like) may transmit, on a sidelink, information indicating a set of sidelink random access configurations corresponding to a set of uplink random access configurations, as described above.

As further shown in FIG. 5, in some aspects, process 500 may include receiving, on the sidelink and from a secondary UE, a random access signal based at least in part on a selected sidelink random access configuration of the set of sidelink random access configurations, wherein the selected sidelink random access configuration corresponds to a selected uplink random access configuration of the set of uplink random access configurations (block 520). For example, the primary UE (e.g., using antenna 252, DEMOD 254, MIMO detector 256, receive processor 258, controller/processor 280, and/or the like) may receive, on the sidelink and from a secondary UE, a random access signal based at least in part on a selected sidelink random access configuration of the set of sidelink random access configurations, as described above. In some aspects, the selected sidelink random access configuration corresponds to a selected uplink random access configuration of the set of uplink random access configurations.

As further shown in FIG. 5, in some aspects, process 500 may include selectively performing a random access procedure in accordance with the selected uplink random access configuration (block 530). For example, the primary UE (e.g., using controller/processor 280, transmit processor 264, TX MIMO processor 266, MOD 254, antenna 252, and/or the like) may selectively perform a random access procedure in accordance with the selected uplink random access configuration, as described above.

Process 500 may include additional aspects, such as any single aspect or any combination of aspects described below and/or in connection with one or more other processes described elsewhere herein.

In a first aspect, the selected sidelink random access configuration indicates at least one of a sidelink preamble sequence for the random access signal or a sidelink random access channel (RACH) occasion for the random access signal.

In a second aspect, alone or in combination with the first aspect, the information indicating the set of sidelink random access configurations is transmitted in a sidelink system information block (SIB).

In a third aspect, alone or in combination with one or more of the first and second aspects, the set of uplink random access configurations are associated with respective synchronization signal blocks.

In a fourth aspect, alone or in combination with one or more of the first through third aspects, the set of sidelink random access configurations indicate one or more time-frequency resource configurations for subsequent communications between the primary UE and the secondary UE.

In a fifth aspect, alone or in combination with one or more of the first through fourth aspects, the random access signal is associated with a lower transmit power than a random access signal transmitted by the primary UE in connection with the random access procedure.

In a sixth aspect, alone or in combination with one or more of the first through fifth aspects, relative to a random access signal transmitted by the primary UE in connection with the random access procedure, the random access signal received by the primary UE is associated with at least one of: a smaller set of possible preamble sequences, a smaller subcarrier spacing, a shorter preamble sequence, or a smaller cyclic shift.

In a seventh aspect, alone or in combination with one or more of the first through sixth aspects, the selected uplink random access configuration is a selected random access configuration of the secondary UE, and the process 500 further comprises selecting a selected random access configuration of the primary UE, wherein selectively performing the random access procedure in accordance with the selected uplink random access configuration is based at least in part on whether the selected random access configuration of the primary UE matches the selected random access configuration of the secondary UE.

In an eighth aspect, alone or in combination with one or more of the first through seventh aspects, process 500 includes transmitting information to the secondary UE based at least in part on selectively performing the random access procedure in accordance with the selected uplink random access configuration.

In a ninth aspect, alone or in combination with one or more of the first through eighth aspects, the information indicates whether the random access procedure is successful.

In a tenth aspect, alone or in combination with one or more of the first through ninth aspects, the information indicates that the random access procedure is successful.

In an eleventh aspect, alone or in combination with one or more of the first through tenth aspects, the information includes a random access response.

In a twelfth aspect, alone or in combination with one or more of the first through eleventh aspects, selectively performing the random access procedure in accordance with the selected uplink random access configuration comprises performing the random access procedure using a random access preamble associated with a repetition level to be used for a reception by the secondary UE.

In a thirteenth aspect, alone or in combination with one or more of the first through twelfth aspects, the selected uplink random access configuration is selected by the secondary UE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a UE, in accordance with various aspects of the present disclosure. Example process 600 is an example where a secondary UE (e.g., UE 120, the secondary UE 120 of FIG. 4, and/or the like) performs operations associated with random access for a secondary UE.

As shown in FIG. 6, in some aspects, process 600 may include determining a selected uplink random access configuration for a random access procedure (block 610). For example, the secondary UE (e.g., using antenna 252, DEMOD 254, MIMO detector 256, receive processor 258, controller/processor 280, and/or the like) may determine a selected uplink random access configuration for a random access procedure, as described above.

As further shown in FIG. 6, in some aspects, process 600 may include receiving, on a sidelink and from a primary UE, system information indicating a sidelink random access configuration corresponding to the selected uplink random access configuration (block 620). For example, the secondary UE (e.g., using antenna 252, DEMOD 254, MIMO detector 256, receive processor 258, controller/processor 280, and/or the like) may receive, on a sidelink and from a primary UE, system information indicating a sidelink random access configuration corresponding to the selected uplink random access configuration, as described above.

As further shown in FIG. 6, in some aspects, process 600 may include transmitting, on the sidelink and to the primary UE, a random access signal indicated by the sidelink random access configuration (block 630). For example, the secondary UE (e.g., using controller/processor 280, transmit processor 264, TX MIMO processor 266, MOD 254, antenna 252, and/or the like) may transmit, on the sidelink and to the primary UE, a random access signal indicated by the sidelink random access configuration, as described above.

Process 600 may include additional aspects, such as any single aspect or any combination of aspects described below and/or in connection with one or more other processes described elsewhere herein.

In a first aspect, the selected sidelink random access configuration indicates at least one of a sidelink preamble sequence for the random access signal or a sidelink random access channel (RACH) occasion for the random access signal.

In a second aspect, alone or in combination with the first aspect, process 600 includes receiving, from a base station, a synchronization signal block, wherein the random access procedure is associated with the base station, and wherein the UE transmits the random access signal in accordance with a sidelink random access channel (RACH) occasion and a sidelink random access preamble that are selected based at least in part on the synchronization signal block and the selected uplink random access configuration.

In a third aspect, alone or in combination with one or more of the first and second aspects, the system information comprises a sidelink system information block.

In a fourth aspect, alone or in combination with one or more of the first through third aspects, process 600 includes receiving information from the primary UE indicating whether the random access procedure was successfully performed by the primary UE on behalf of the secondary UE.

In a fifth aspect, alone or in combination with one or more of the first through fourth aspects, process 600 includes receiving information from the primary UE indicating that the random access procedure was successfully performed by the primary UE on behalf of the secondary UE.

In a sixth aspect, alone or in combination with one or more of the first through fifth aspects, process 600 includes receiving a random access response, associated with the random access procedure, from the primary UE.

In a seventh aspect, alone or in combination with one or more of the first through sixth aspects, the sidelink random access configuration indicates one or more time-frequency resource configurations for communications between the primary UE and the secondary UE.

In an eighth aspect, alone or in combination with one or more of the first through seventh aspects, the random access signal is associated with a lower transmit power than a random access signal for a base station.

In a ninth aspect, alone or in combination with one or more of the first through eighth aspects, relative to a random access signal for a base station, the random access signal transmitted by the secondary UE is associated with at least one of: a smaller set of possible preamble sequences, a smaller subcarrier spacing, a shorter preamble sequence, or a smaller cyclic shift.

In a tenth aspect, alone or in combination with one or more of the first through ninth aspects, process 600 includes receiving, from the primary UE, information indicating a preamble sequence for the random access procedure; and receiving, from a base station, a random access message of the random access procedure based at least in part on the preamble sequence.

In an eleventh aspect, alone or in combination with one or more of the first through tenth aspects, process 600 includes receiving, from a base station, a random access message of the random access procedure, wherein a preamble sequence used by the primary UE for the random access procedure is indicated by the sidelink random access configuration, and wherein the random access message is received based at least in part on the preamble sequence.

In a twelfth aspect, alone or in combination with one or more of the first through eleventh aspects, process 600 includes receiving, from a base station, a random access message of the random access procedure; and performing a transmission using a timing correction associated with the random access message.

In a thirteenth aspect, alone or in combination with one or more of the first through twelfth aspects, process 600 includes receiving, from a base station, a communication with a plurality of repetitions, wherein the plurality of repetitions is being based at least in part on a preamble sequence used to perform the random access procedure.

In a fourteenth aspect, alone or in combination with one or more of the first through thirteenth aspects, the secondary UE is a low-power UE or a low-complexity UE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with various aspects of the present disclosure. Example process 700 is an example where the base station (e.g., BS 110 and/or the like) performs operations associated with random access for a secondary UE.

As shown in FIG. 7, in some aspects, process 700 may include receiving a random access signal associated with a random access procedure, wherein the random access signal is associated with a group of random access preambles (block 710). For example, the base station (e.g., using antenna 234, DEMOD 232, MIMO detector 236, receive processor 238, controller/processor 240, and/or the like) may receive a random access signal associated with a random access procedure, as described above. In some aspects, the random access signal is associated with a group of random access preambles.

As further shown in FIG. 7, in some aspects, process 700 may include determining a repetition scheme for a transmission of the base station based at least in part on the random access signal (block 720). For example, the base station (e.g., using antenna 234, DEMOD 232, MIMO detector 236, receive processor 238, controller/processor 240, and/or the like) may determine a repetition scheme for a transmission of the base station based at least in part on the random access signal, as described above.

As further shown in FIG. 7, in some aspects, process 700 may include performing the transmission using the repetition scheme (block 730). For example, the base station (e.g., using controller/processor 240, transmit processor 220, TX MIMO processor 230, MOD 232, antenna 234, and/or the like) may perform the transmission using the repetition scheme, as described above.

Process 700 may include additional aspects, such as any single aspect or any combination of aspects described below and/or in connection with one or more other processes described elsewhere herein.

In a first aspect, the random access signal is received from a primary UE, and the transmission is to a secondary UE.

In a second aspect, alone or in combination with the first aspect, the repetition scheme is one of a plurality of repetition schemes, and the plurality of repetition schemes are associated with respective groups of random access preambles.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a primary user equipment (UE), comprising:
transmitting, on a sidelink, information indicating a set of sidelink random access configurations corresponding to a set of uplink random access configurations;
receiving, on the sidelink and from a secondary UE, a random access signal based at least in part on a selected sidelink random access configuration of the set of sidelink random access configurations,
wherein the selected sidelink random access configuration corresponds to a selected uplink random access configuration of the set of uplink random access configurations; and
selectively performing a random access procedure in accordance with the selected uplink random access configuration.

2. The method of claim 1, wherein the selected sidelink random access configuration indicates at least one of a sidelink preamble sequence for the random access signal or a sidelink random access channel (RACH) occasion for the random access signal.

3. The method of claim 1, wherein the information indicating the set of sidelink random access configurations is transmitted in a sidelink system information block (SIB).

4. The method of claim 1, wherein the set of uplink random access configurations are associated with respective synchronization signal blocks.

5. The method of claim 1, wherein the set of sidelink random access configurations indicate one or more time-frequency resource configurations for subsequent communications between the primary UE and the secondary UE.

6. The method of claim 1, wherein the random access signal is associated with a lower transmit power than a random access signal transmitted by the primary UE in connection with the random access procedure.

7. The method of claim 1, wherein, relative to a random access signal transmitted by the primary UE in connection with the random access procedure, the random access signal received by the primary UE is associated with at least one of:
a smaller set of possible preamble sequences,
a smaller subcarrier spacing,
a shorter preamble sequence, or
a smaller cyclic shift.

8. The method of claim 1, wherein the selected uplink random access configuration is a selected random access configuration of the secondary UE, and wherein the method further comprises:
selecting a selected random access configuration of the primary UE,
wherein selectively performing the random access procedure in accordance with the selected uplink random access configuration is based at least in part on whether the selected random access configuration of the primary UE matches the selected random access configuration of the secondary UE.

9. The method of claim 1, further comprising:
transmitting information to the secondary UE based at least in part on selectively performing the random access procedure in accordance with the selected uplink random access configuration.

10. The method of claim 9, wherein the information indicates whether the random access procedure is successful.

11. The method of claim 9, wherein the information indicates that the random access procedure is successful.

12. The method of claim 9, wherein the information includes a random access response.

13. The method of claim 1, wherein selectively performing the random access procedure in accordance with the selected uplink random access configuration comprises:
performing the random access procedure using a random access preamble associated with a repetition level to be used for a reception by the secondary UE.

14. The method of claim 1, wherein the selected uplink random access configuration is selected by the secondary UE.

15. A method of wireless communication performed by a secondary user equipment (UE), comprising:
determining a selected uplink random access configuration for a random access procedure;
receiving, on a sidelink and from a primary UE, system information indicating a sidelink random access configuration corresponding to the selected uplink random access configuration; and
transmitting, on the sidelink and to the primary UE, a random access signal indicated by the sidelink random access configuration.

16. The method of claim 15, wherein the selected sidelink random access configuration indicates at least one of a sidelink preamble sequence for the random access signal or a sidelink random access channel (RACH) occasion for the random access signal.

17. The method of claim 15, further comprising:
receiving, from a base station, a synchronization signal block, wherein the random access procedure is associated with the base station, and wherein the UE transmits the random access signal in accordance with a sidelink random access channel (RACH) occasion and a sidelink random access preamble that are selected in accordance with the synchronization signal block and the selected uplink random access configuration.

18. The method of claim 15, wherein the system information comprises a sidelink system information block.

19. The method of claim 15, further comprising:
receiving information from the primary UE indicating whether the random access procedure was successfully performed by the primary UE on behalf of the secondary UE.

20. The method of claim 15, further comprising:
receiving information from the primary UE indicating that the random access procedure was successfully performed by the primary UE on behalf of the secondary UE.

21. The method of claim 15, further comprising:
receiving a random access response, associated with the random access procedure, from the primary UE.

22. The method of claim 15, wherein the sidelink random access configuration indicates one or more time-frequency resource configurations for communications between the primary UE and the secondary UE.

23. The method of claim 15 wherein the random access signal is associated with a lower transmit power than a random access signal for a base station.

24. The method of claim 15, wherein, relative to a random access signal for a base station, the random access signal transmitted by the secondary UE is associated with at least one of:
a smaller set of possible preamble sequences,
a smaller subcarrier spacing,
a shorter preamble sequence, or
a smaller cyclic shift.

25. The method of claim 15, further comprising:
receiving, from the primary UE, information indicating a preamble sequence for the random access procedure; and
receiving, from a base station, a random access message of the random access procedure based at least in part on the preamble sequence.

26. The method of claim 15, further comprising:
receiving, from a base station, a random access message of the random access procedure, wherein a preamble sequence used by the primary UE for the random access procedure is indicated by the sidelink random access configuration, and wherein the random access message is received based at least in part on the preamble sequence.

27. The method of claim 15, further comprising:
receiving, from a base station, a random access message of the random access procedure; and
performing a transmission using a timing correction associated with the random access message.

28. The method of claim 15, further comprising:
receiving, from a base station, a communication with a plurality of repetitions, wherein the plurality of repetitions are based at least in part on a preamble sequence used to perform the random access procedure.

29. The method of claim 15, wherein the secondary UE is a low-power UE or a low-complexity UE.

30. A method of wireless communication performed by a base station, comprising:
receiving a random access signal associated with a random access procedure, wherein the random access signal is associated with a group of random access preambles;
determining a repetition scheme for a transmission of the base station based at least in part on the random access signal; and
performing the transmission using the repetition scheme.

31. The method of claim 30, wherein the random access signal is received from a primary UE, and wherein the transmission is to a secondary UE.

32. The method of claim 30, wherein the repetition scheme is one of a plurality of repetition schemes, and wherein the plurality of repetition schemes are associated with respective groups of random access preambles.

33. A primary user equipment (UE) for wireless communication, comprising:
a memory; and
one or more processors coupled to the memory and configured to:
transmit, on a sidelink, information indicating a set of sidelink random access configurations corresponding to a set of uplink random access configurations;
receive, on the sidelink and from a secondary UE, a random access signal based at least in part on a selected sidelink random access configuration of the set of sidelink random access configurations,
wherein the selected sidelink random access configuration corresponds to a selected uplink random access configuration of the set of uplink random access configurations; and
selectively perform a random access procedure in accordance with the selected uplink random access configuration.

34-42. (canceled)

43. The primary UE of claim 33, wherein the selected sidelink random access configuration indicates at least one of a sidelink preamble sequence for the random access signal or a sidelink random access channel (RACH) occasion for the random access signal.

44. The primary UE of claim 33, wherein the information indicating the set of sidelink random access configurations is transmitted in a sidelink system information block (SIB).
